(19) United States
(12) Patent Application Publication
(10) Pub. No.: US 2019/0152698 A1
(43) Pub. Date: May 23, 2019

(54) INTELLIGENT TRASH CAN

(71) Applicant: Lei ZHAO, Shijiazhuang (CN)

(72) Inventor: Lei ZHAO, Shijiazhuang (CN)

(21) Appl. No.: 16/251,104

(22) Filed: Jan. 18, 2019

(51) Int. Cl. B65F 1/16; B65F 1/06

(52) U.S. Cl. CPC B65F 1/1638; B65F 2001/1676; B65F 2001/061; B65F 1/06

(57) ABSTRACT

An intelligent trash can includes a can body, a frame cover, a can cap, a sealing mechanism, a first motor, a second motor, a control circuit board, a sensor and a switch. The can body and the frame cover are in a rotational configuration; the first motor drives the frame cover to rotate; the can cap and the frame cover are in a rotational configuration; and the second motor drives the can cap. A trash bag is disposed in the frame cover; the sealing mechanism is arranged in the can body; and the sealing mechanism, the switch, the first motor, the second motor and the sensor are respectively electrically connected to the circuit board. The sensor detects an external signal for analysis. The switch sends a command for analysis. After the sealing, the control circuit board sends a control command.

### TECHNICAL FIELD

The invention relates to an intelligent trash can, belonging to the technical field of cleaning supplies.

### BACKGROUND

Trash cans are necessary living goods. Traditional trash cans do not have a sealing function, and are common in appearance and singular in shape. To handle trash, a user needs to place a trash bag in a trash can first; after the trash bag is fully filled in with trash, the trash bag full of trash shall be taken out and manually tied and sealed. By performing this operation, the user inevitably touches the inner side of the bag with hands, which may cause contact with bacterial pollution, and is also inconvenient and unhygienic.

### SUMMARY

The objective of the invention is to provide an intelligent trash can which has a reasonable structural design, is capable of realizing an automatic bagging operation, and automatically packs the trash bag, to overcome the above-mentioned defects in the prior art.

The invention adopts the following technical solution to solve the above-mentioned problems. An intelligent trash can includes a can body, a frame cover, a can cap, a sealing mechanism, a first motor, a second motor, a control circuit board, a sensor and a switch; the can body and the frame cover are in a rotational configuration; the first motor drives the frame cover to rotate; the can cap and the frame cover are in a rotational configuration; the second motor drives the can cap; a trash bag is disposed in the frame cover; the mouth of the trash bag is supported by the frame cover; the body of the trash bag extends into the can body. The sealing mechanism is arranged in the can body; the sealing mechanism seals the trash bag; the sealing mechanism, the switch, the first motor, the second motor and the sensor are respectively electrically connected with the circuit board; the sensor detects an external signal and sends the detected signal to the control circuit board; the control circuit board analyzes the signal and sends a control command to the second motor. The switch is triggered to send a command to the control circuit; the control circuit board analyzes the command and sends a control command to the sealing mechanism; after the sealing mechanism completes sealing, the control circuit board sends a control command to the first motor.

In the invention, the sealing mechanism includes a first belt, a third motor, a second belt, a fourth motor, a cross bar, a longitudinal bar, a first guide rod, a second guide rod and an electric heating member; the third motor and the fourth motor are respectively fixedly connected to the trash can; the first guide rod is in a sliding connection with the cross bar; the second guide rod is in a sliding direction with the longitudinal bar; the third motor drives the cross bar by the first belt to linearly move along the first guide rod; the fourth motor drives the longitudinal bar by the second belt to linearly move along the second guide rod; and the electric heating member is disposed on the cross bar, longitudinal bar, or trash can.

In the invention, the longitudinal rod is formed with a sliding chute, and one end of the cross bar is disposed in the sliding chute.

In the invention, the electric heating member is disposed in the can body; and the cross bar is provided with a piece of high-temperature resistant cloth at a position corresponding to the electric heating member.

In the invention, the cross bar has one end formed with a first through-hole for sleeving the first guide rod.

In the invention, the longitudinal bar has one end formed with a second through-hole for sleeving the second guide rod.

In the invention, the cross bar is formed with a clamping groove for mounting the first belt; the first belt is provided with first saw teeth; the clamping groove is provided with second saw teeth; and the first saw teeth are meshed with the second saw teeth.

In the invention, the third motor has an output shaft that is provided with third saw teeth matched with the first saw teeth.

In the invention, the longitudinal bar is formed with a clamping groove for mounting the second belt; the second belt is provided with fourth saw teeth; the clamping groove is provided with fifth saw teeth; and the fourth saw teeth are meshed with the fifth saw teeth.

In the invention, a micro-switch is also included, and the cross bar and/or longitudinal bar touches the micro-switch in the movement journey.

In the invention, the can body has a side wall formed with a vent hole, and a fan is arranged at the position of an air outlet.

In the invention, the trash bag only has a bag bottom, and the side wall of the trash bag extends and is cascaded and contained in the frame cover.

Compared with the prior art, the invention has the following advantages and effects:

1. When the invention is used, it does not need to manually sleeve the trash bag; and after the trash bag is full of trash, the can is capable of automatically packing and sealing. The invention is highly automated and is very conveniently used.

2. According to the invention, the cross bar and the longitudinal bar respectively linearly move in the transverse and longitudinal directions to close up the trash bag, achieving a good sealing effect; and the electric heating member thermally seals the closed trash bag. Compared with the prior art, the invention avoids closing up the trash bag by hand, and the operation is more hygienic and convenient.

### BRIEF DESCRIPTION OF THE DRAWINGS

FIG. 1 is a structural view of an embodiment;

FIG. 2 is a structural view of the embodiment in a sectional view angle;

FIG. 3 is an electric control view of the embodiment; and

FIG. 4 is a structural view of a sealing mechanism of the embodiment.

### DETAILED DESCRIPTION OF THE EMBODIMENTS

The invention is described in further detail in conjunction with the attached drawings and embodiments. The following embodiments are presented to explain the invention instead of limiting the invention.

### Embodiment 1

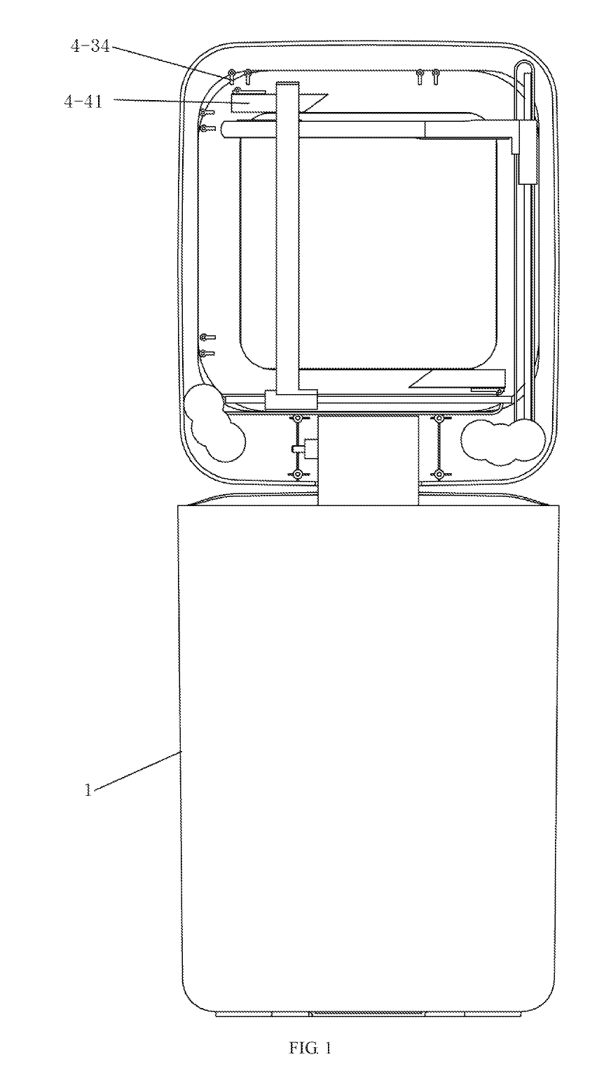

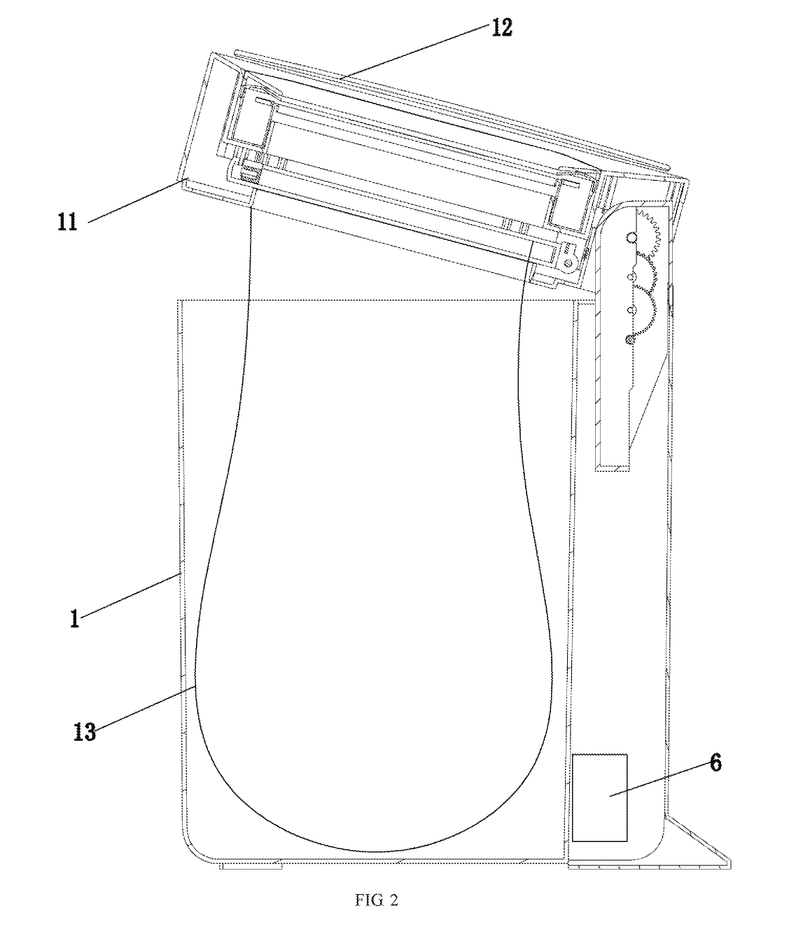

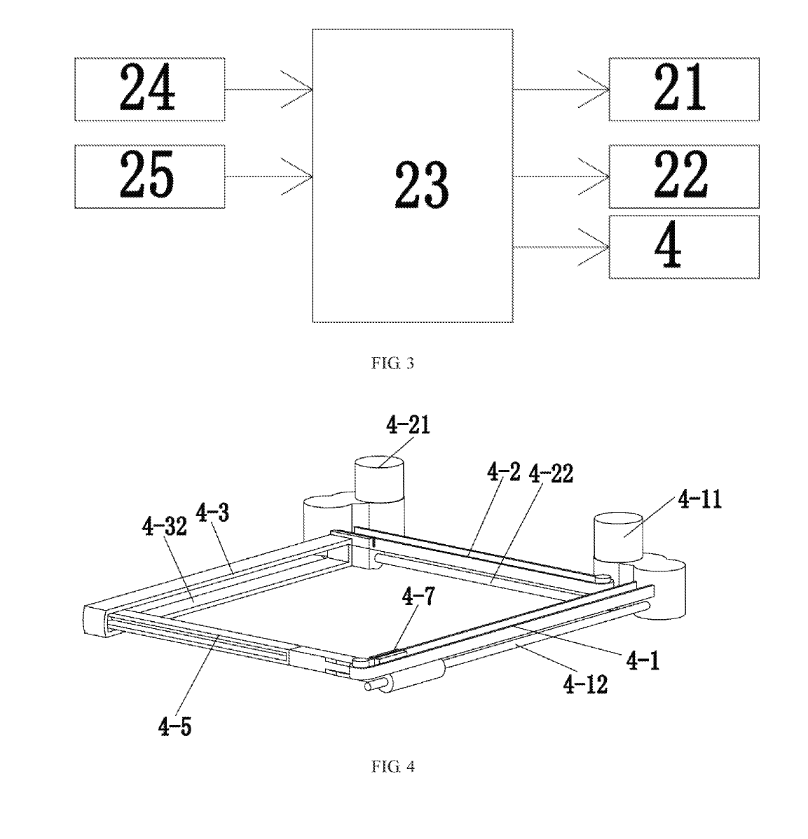

Referring to FIGS. 1-4, an intelligent trash can of this embodiment includes a can body 1, a frame cover 11, a can cap 12, a sealing mechanism 4, a first motor 21, a second motor 22, a control circuit board 23, a sensor 24 and a switch 25; the can body 1 and the frame cover 11 are in a rotational configuration; the first motor 21 drives the frame cover 11 to rotate; the can cap 12 and the frame cover 11 are in a rotational configuration; the second motor 22 drives the can cap 12; a trash bag 13 is disposed in the frame cover 11; the mouth of the trash bag 13 is supported by the frame cover 11; and the body of the trash bag extends into the can body 1. The sealing mechanism 4 is arranged in the can body 1; the sealing mechanism 4 seals the trash bag 13; the sealing mechanism 4, the switch 25, the first motor 21, the second motor 22 and the sensor 24 are respectively electrically connected with the circuit board 23; the sensor 24 detects an external signal and sends the detected signal to the control circuit board 23; the control circuit board 23 analyzes the signal and sends a control command to the second motor 22. The switch 25 is triggered to send a command to the control circuit board 23; the control circuit board 23 analyzes the command and sends a control command to the sealing mechanism 4; after the sealing mechanism 4 completes sealing, the control circuit board 23 sends a control command to the first motor 21. The control circuit board 23 includes a first single chip machine and a peripheral circuit. As an optimization, the sensor 24 is an infrared sensor 24. When the intelligent trash can is used, the infrared sensor 24 detects that a user needs to throw the trash away, the motor 22 drives the can cap 12 to open; after the user throws the trash away, the can cap 12 closes; when the trash bag is full, the user triggers the switch 25 such that the sealing mechanism 4 seals the trash bag 13; then, the first motor 21 drives the frame cover 11 to open; the user can take out the sealed trash bag 13. After the frame cover 11 covers the trash can, the user can throw the trash into the trash can again, without any bagging operation. The use is very convenient and hygienic.

In the invention, the sealing mechanism 4 includes a first belt 4-1, a third motor 4-11, a second belt 4-2, a fourth motor 4-21, a cross bar 4-5, a longitudinal bar 4-3, a first guide rod 4-12, a second guide rod 4-22 and an electric heating member 4-41; the third motor 4-11 and the fourth motor 4-21 are respectively fixedly connected to the can body 1 or frame cover 11 of the trash can; the first guide rod 4-12 is in a sliding connection with the cross bar 4-5; the second guide rod 4-22 is in a sliding direction with the longitudinal bar 4-3; the third motor 4-11 drives the cross bar 4-5 by the first belt 4-1 to linearly move along the first guide rod 4-12; the fourth motor 4-21 drives the longitudinal bar 4-3 by the second belt 4-2 to linearly move along the second guide rod 4-22; and the electric heating member 4-41 is disposed on the cross bar 4-5, longitudinal bar 4-3 or trash can.

As an optimization, the longitudinal rod 4-3 of the invention is formed with a sliding chute 4-32, and one end of the cross bar 4-5 is disposed in the sliding chute 4-32.

As an optimization, the electric heating member 4-41 of this embodiment is disposed in the can body 1; and the cross bar 4-5 is provided with a piece of high-temperature resistant cloth at a position corresponding to the electric heating member 4-41.

As an optimization, the cross bar 4-5 of this embodiment has one end formed with a first through-hole for sleeving the first guide rod 4-12.

As an optimization, the longitudinal bar 4-3 of this embodiment has one end formed with a second through-hole for sleeving the second guide rod 4-22.

As an optimization, the cross bar 4-5 of this embodiment is formed with a clamping groove for mounting the first belt 4-1; the first belt 4-1 is provided with first saw teeth; the clamping groove is provided with second saw teeth; and the first saw teeth are meshed with the second saw teeth.

In this embodiment, the third motor 4-11 has an output shaft that is provided with third saw teeth matched with the first saw teeth.

In this embodiment, the longitudinal bar 4-3 is formed with a clamping groove for mounting the second belt 4-2; the second belt 4-2 is provided with fourth saw teeth; the clamping groove is provided with fifth saw teeth; and the fourth saw teeth are meshed with the fifth saw teeth.

This embodiment also includes a micro-switch 4-34, and the cross bar 4-5 and/or longitudinal bar 4-3 touches the micro-switch 4-34 in the movement journey. When moving linearly, the cross bar 4-5 and the longitudinal bar 4-3 touch the micro-switch 34, so that the micro-switch 34 is triggered to generate a control signal that can adjust the operating state of the third motor 4-11 or/and the fourth motor 4-21, wherein the operating status includes start/stop and forward/reverse operation of the motor.

In this embodiment, the can body 1 has a side wall formed with a vent hole, and a fan 6 is arranged at the position of an air outlet. The fan extracts air, capable of sucking the trash bag 13 downward to fit in the can body 1.

In this embodiment, the trash bag 13 only has a bag bottom, and the side wall of the trash bag 13 extends and is cascaded and contained in the frame cover.

The above contents in the description are merely an exemplary illustration of the structure of the invention. Those skilled in the technical field that the invention belongs to can make various modifications or supplementations or similar substations on the specific embodiments, and all the modifications or supplementations or similar substations without departing from the contents of the description of the invention or going beyond the scope defined by the claims shall fall within the protective scope of the invention.

What is claimed is:

1. An intelligent trash can, comprising: a can body, a frame cover, a can cap, a sealing mechanism, a first motor, a second motor, a control circuit board, a sensor, and a switch; wherein
the can body and the frame cover are in a first rotational configuration, and the first motor drives the frame cover to rotate;
the can cap and the frame cover are in a second rotational configuration, and the second motor drives the can cap;
a trash bag is disposed in the frame cover, a mouth of the trash bag is supported by the frame cover, and a body of the trash bag extends into the can body;
the sealing mechanism is arranged in the can body, the sealing mechanism seals the trash bag, and the sealing mechanism, the switch, the first motor, the second motor and the sensor are respectively electrically connected to the circuit board;
the sensor detects an external signal and sends the external signal to the control circuit board, and the control circuit board analyzes the external signal and sends a first control command to the second motor; and
the switch is triggered to send a command to the control circuit board, the control circuit board analyzes the command and sends a second control command to the sealing mechanism, and after the sealing mechanism completes a sealing, the control circuit board sends a third control command to the first motor.

2. The intelligent trash can according to claim 1, wherein
the sealing mechanism comprises a first belt, a third motor, a second belt, a fourth motor, a cross bar, a longitudinal bar, a first guide rod, a second guide rod, and an electric heating member;
the third motor and the fourth motor are respectively fixedly connected to the trash can, the third motor drives the cross bar by the first belt to linearly move along the first guide rod, and the fourth motor drives the longitudinal bar through the second belt to linearly move along the second guide rod;
the first guide rod is in a sliding connection with the cross bar, and the second guide rod is in a sliding direction with the longitudinal bar; and
the electric heating member is disposed on the cross bar, longitudinal bar, or trash can.

3. The intelligent trash can according to claim 2, wherein a longitudinal rod is formed with a sliding chute, and a first end of the cross bar is disposed in the sliding chute.

4. The intelligent trash can according to claim 3, wherein the electric heating member is disposed in the can body, and the cross bar is provided with a piece of high-temperature resistant cloth at a position corresponding to the electric heating member.

5. The intelligent trash can according to claim 2, wherein the cross bar comprises a second end, and the second end of the cross bar is formed with a first through-hole for sleeving the first guide rod.

6. The intelligent trash can according to claim 2, wherein the longitudinal bar comprises one end formed with a second through-hole for sleeving the second guide rod.

7. The intelligent trash can according to claim 2, wherein the cross bar is formed with a clamping groove for mounting the first belt, the first belt is provided with first saw teeth, the clamping groove is formed with second saw teeth, and the first saw teeth are meshed with the second saw teeth.

8. The intelligent trash can according to claim 6, wherein the third motor comprises an output shaft, the output shaft is provided with third saw teeth, and the third saw teeth are matched with first saw teeth.

9. The intelligent trash can according to claim 2, wherein the longitudinal bar is formed with a clamping groove for mounting the second belt, the second belt is provided with fourth saw teeth, the clamping groove is provided with fifth saw teeth, and the fourth saw teeth are meshed with the fifth saw teeth.

10. The intelligent trash can according to claim 2, further comprising: a micro-switch; wherein the cross bar and/or longitudinal bar touches the micro-switch in a movement journey.

11. The intelligent trash can according to claim 2, wherein the can body comprises a side wall, the side wall of the can body is formed with a vent hole, and a fan is arranged at a position of an air outlet.

12. The intelligent trash can according to claim 1, wherein the trash bag comprises a bag bottom, and a side wall of the trash bag extends into the frame cover, and the side wall of the trash bag is cascaded and contained in the frame cover.

13. The intelligent trash can according to claim 3, wherein the cross bar is formed with a clamping groove for mounting the first belt, the first belt is provided with first saw teeth, the clamping groove is formed with second saw teeth, and the first saw teeth are meshed with the second saw teeth.

14. The intelligent trash can according to claim 4, wherein the cross bar is formed with a clamping groove for mounting the first belt, the first belt is provided with first saw teeth, the clamping groove is formed with second saw teeth, and the first saw teeth are meshed with the second saw teeth.

15. The intelligent trash can according to claim 3, wherein the longitudinal bar is formed with a clamping groove for mounting the second belt, the second belt is provided with fourth saw teeth, the clamping groove is provided with fifth saw teeth, and the fourth saw teeth are meshed with the fifth saw teeth.

16. The intelligent trash can according to claim 4, wherein the longitudinal bar is formed with a clamping groove for mounting the second belt, the second belt is provided with fourth saw teeth, the clamping groove is provided with fifth saw teeth, and the fourth saw teeth are meshed with the fifth saw teeth.

17. The intelligent trash can according to claim 5, wherein the longitudinal bar is formed with a clamping groove for mounting the second belt, the second belt is provided with fourth saw teeth, the clamping groove is provided with fifth saw teeth, and the fourth saw teeth are meshed with the fifth saw teeth.

18. The intelligent trash can according to claim 3, further comprising: a micro-switch; wherein the cross bar and/or longitudinal bar touches the micro-switch in a movement journey.

19. The intelligent trash can according to claim 4, further comprising: a micro-switch; wherein the cross bar and/or longitudinal bar touches the micro-switch in a movement journey.

20. The intelligent trash can according to claim 5, further comprising: a micro-switch; wherein the cross bar and/or longitudinal bar touches the micro-switch in a movement journey.
